(19) United States
(12) Patent Application Publication
(10) Pub. No.: US 2005/0177799 A1
(43) Pub. Date: Aug. 11, 2005

(54) Method of associating an icon with a temporary profile

(76) Inventors: Juliet F. Knight, Lexington, KY (US); Christopher S. Faro, Lexington, KY (US); Charles E. Gregory, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/772,747

(22) Filed: Feb. 5, 2004

(51) Int. Cl. G06F 3/00

(52) U.S. Cl. 715/810; 715/811; 715/745; 715/789

(57) ABSTRACT

A method of associating an icon with a profile in a device store. The device, such as a multifunction printer, includes a configurable graphical user interface and is in communication with a host. The method includes creating a profile associated with at least one action of the device, placing an icon on the graphical user interface upon a request for the acquisition of data from the host, associating the profile with the icon, and deleting the icon and profile from the device upon the occurrence of an action. The action can include the acquisition of the requested data or the expiration of a time-to-live variable assigned to the profile.

### BACKGROUND OF THE INVENTION

Some multifunctional imaging devices, such as multifunction printers (MFPs) have a graphical user interface or touch screen to show the status of the device, allow user interaction, prompt user actions, or the like. Icons are typically generated for display on the screen, and these icons are associated with the functions of the MFP. In an office setting, most MFPs can perform many operations, which can require several icons to be displayed on the screen at one time. In a setting where multiple users may be sending requests to the MFP at one time, it is desirable to provide a way for the user to be able to recognize which information request is theirs to simplify the use of the MFP.

### SUMMARY OF THE INVENTION

The present invention provides a method of associating an icon with a profile in a device store. More particularly, the device is in communication with a host and has a configurable graphical user interface. The method includes creating a profile that is associated with at least one action of the device and generating an icon for display on the graphical user interface upon a request from the host for the acquisition of data. The icon is associated with the profile. The icon and profile are then deleted from the device upon the occurrence of an action.

In one embodiment, the action is the acquisition of the requested data. In another embodiment, the method includes assigning a time-to-live variable to the profile, and the icon and profile are deleted upon the expiration of the time-to-live variable.

Further aspects of the present invention, together with the organization and operation thereof, will become apparent from the following detailed description of the invention when taken in conjunction with the accompanying drawings.

### BRIEF DESCRIPTION OF THE DRAWINGS

FIG. 1 is an illustration of one embodiment of a network hosting one or more multifunctional imaging devices of the present invention.

FIG. 2 is an exemplary illustration showing a sequence of icons and information displayed on a graphical user interface of a multifunctional imaging device.

FIG. 3 is a flow diagram illustrating the steps of the method according to the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. The order of limitations specified in any method claims does not imply that the steps or acts set forth therein must be performed in that order, unless an order is explicitly set forth in the specification.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and it should be noted that other alternative mechanical configurations are possible.

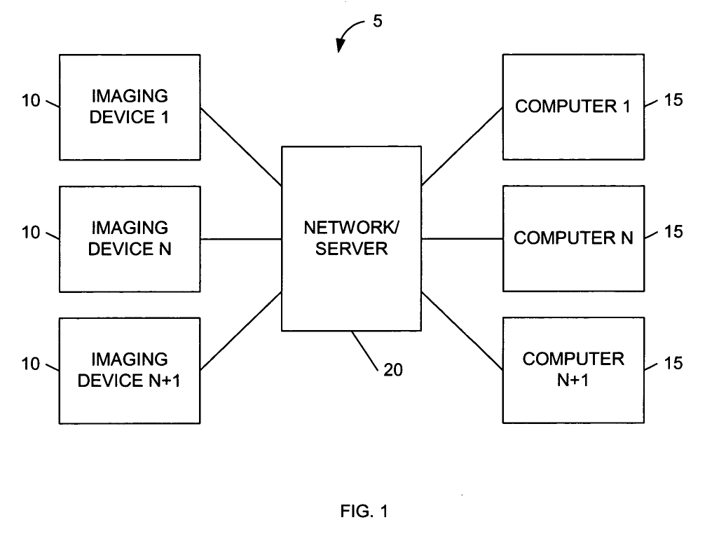

FIG. 1 illustrates a network 5 defining one possible embodiment of the invention. The network includes a plurality of multifunctional imaging devices (“MFPs”) 10, having the capability of performing one or more operations, like printing, scanning, copying, faxing, and emailing, can be found in many business environments. Some businesses have several multifunctional imaging devices 10 dispersed throughout one or more buildings. Some or all of these MFPs 10 can be networked together as shown in FIG. 1. Furthermore, as illustrated in FIG. 1, the MFPs 10 can be networked to one or more hosts, such as computers 15. The computers 15 can send data to any one of the networked MFPs 10 illustrated in FIG. 1 via the network. Additionally, any one of the networked MFPs 10 illustrated in FIG. 1 can also communicate with and/or send information to any one of the computers 15. Although portions of this detailed description are described with respect to the network 20 illustrated in FIG. 1, it is understood that other configurations of a network are possible. Furthermore, it is also understood that a network is not necessarily required to practice some aspects of the present invention.

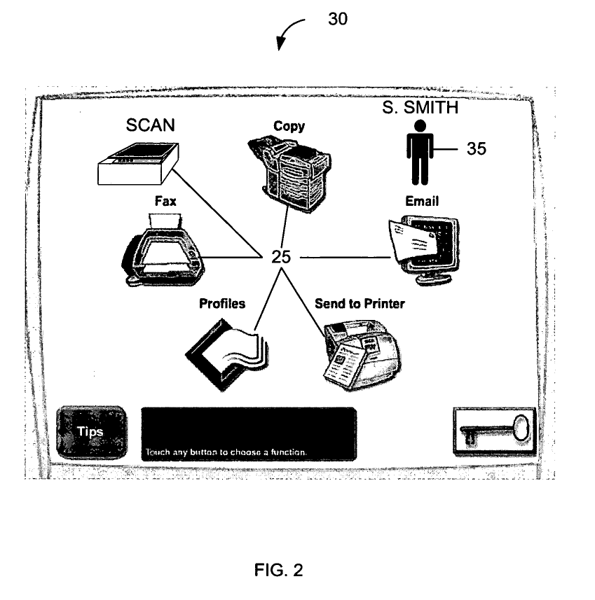

FIG. 2 illustrates one arrangement of icons 25 on a graphical user interface (“GUI”) 30 of the MFP 10. Since these MFPs 10 can perform many operations, several icons 25 may be displayed on the GUI 30 at one time. The GUI 30 of the illustrated embodiment includes a touch screen and thus the terms GUI and touch screen will be used interchangeably throughout the remainder of the detailed description. It is understood that in some embodiments, the GUI 30 may not include a touch screen and that the invention is not limited to GUIs having a touch screen. Other GUIs contemplated by the invention include conventional cathode ray tube display with mouse, cursor or keyboard driven interface, virtual reality interfaces, and voice operated interfaces.

The touch screen has limited space and can include a set maximum number of icons 25, for example, nine icons, at one time. In most conventional devices, the touch screen will have a standard display of icons 25. Some of the icons (and related functions) in the standard display are not used by all users of the MFP 10. Thus, it is desirable in some settings to be able to customize the icon display on the GUI 30 to facilitate use of the MFP 10.

One such setting is in the health care field, such as at a nurse's station in a hospital. It should be understood that the method described below is capable of application to any number of different environments and different businesses, and that the description of use in the health care field is for illustration purposes only.

In a typical nurse's station, there may be a number of computer workstations. Each of those computers 15 may have a standalone document scanner attached and may also be networked to a printer. The nurse's station may also have a standalone fax machine and a standalone copy machine to provide the nurses access to the equipment necessary to perform their duties. This setup has the disadvantage of requiring multiple scanners and separate copy, printer, and fax machines. The duplicative equipment can be costly and can also require a lot of space in a limited environment. However, at least with respect to the standalone scanners, a dedicated scanner provides the ease of one button operation—the nurse places the document to be scanned on the scanning bed, pushes the scan button, and the information is sent to that nurse's computer 15 without further instruction.

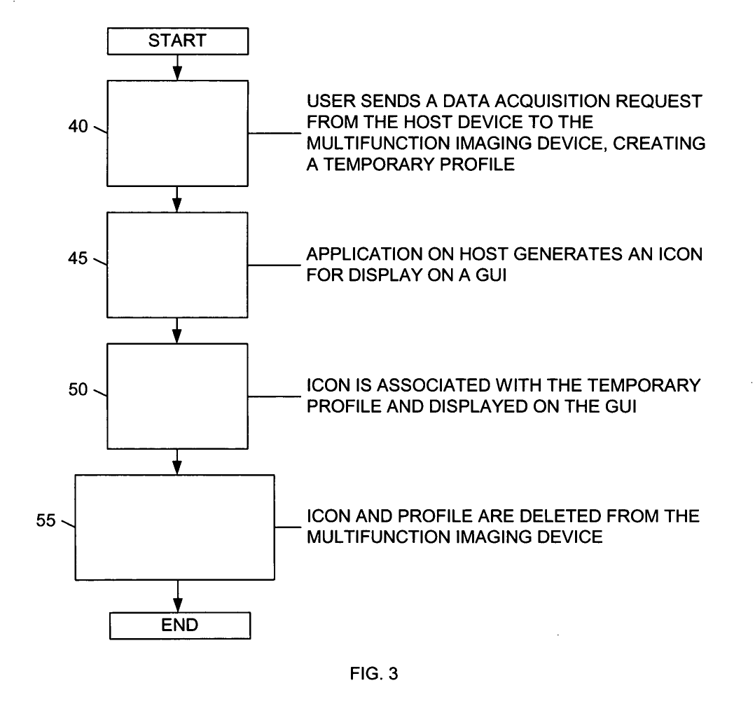

A single MFP 10 can be installed in communication with the computers 15, such as via network server 20, to replace the multiple scanners, copier, printer, and fax machine and perform all of the necessary functions, reducing costs and freeing up space in the nurse's station. With a network device such as an MFP 10 in communication with multiple computers, a need exists for a way to tell the MFP 10 what the parameters of the requested data are and which computer 15 to send the acquired data to. One way to do this is to use various of the icons/buttons 25 that exist on the MFP 10 to scroll through different menus and profile lists to direct the MFP 10 to what information to acquire and to where to send the acquired information. This can be time consuming and complicated. The simple one button scanning operation of a standalone scanner is still desired by the nurses to expedite and simplify the completion of patient records. The method described below and illustrated in FIG. 3 provides this simplicity while allowing the use of an MFP.

A nurse sits down at a computer 15 to create an electronic patient record and opens a software application, such as Cerner ProVision, on the computer 15. It is understood that in other embodiments, the computer 15 could be integrated with the MFP 10 as a single device and the software application may be resident on that device or accessed through the network. The application prompts the nurse to enter certain patient information, such as name, age, condition, etc. The application then prompts the nurse to scan in any pertinent documents that need to become part of the permanent electronic record, such as a picture of the patient, previous paper medical records, or the like. As shown in step 40 of FIG. 3, the nurse (i.e., the nurse's computer 15) sends a request for data acquisition to the MFP 10.

The request for data acquisition automatically causes an application on the computer 15 to compile information into a profile that is sent to and is stored in an MFP store or memory, creating a profile that is temporarily stored on the MFP (i.e., a temporary profile). The profile includes a list of executable instructions to the MFP and includes information such as the scan parameters, the TCP IP address of the nurse's computer 15, and text to be placed on the GUI 30 of the MFP 10. The information in the profile tells the MFP 10 what information is requested and where to send that information once it is acquired by the MFP 10. In essence, the temporary profile points the MFP to pre-selected settings that may be self-contained on the MFP or may be found on the host.

A tool supported by the host, such as a DLL (a callable library) is called to customize the configuration of the GUI 30 of the MFP 10. As illustrated at step 45, the DLL creates a customized icon 35 in response to the request for data acquisition. The temporary profile is associated with the customized icon 35 at step 50. The customized icon 35 can take any form and in some embodiments, could include a picture of the nurse associated with that icon 35.

The DLL communicates with the GUI 30 of the MFP 10 to determine whether the touch screen of the GUI 30 has enough room to accept another icon. If there is not enough space, i.e., if the maximum number of icons 25 already exists on the touch screen, the DLL may continue to poll the MFP 10 until there is enough space available on the touch screen to accept the customized icon 35. Once enough space becomes available, the customized icon 35 may be placed on the GUI 30 of the MFP 10. Any relevant text information found in the profile, such as the name S. Smith as illustrated in FIG. 2, may also be placed on the GUI 30, adjacent to the customized icon 35.

The nurse then can see the customized icon 35 among the other icons 25 on the GUI 30 and knows immediately which request is hers. The nurse places the document to be scanned on the MFP scanner bed and activates the button, represented by the icon 35, to acquire an image of the document. Pushing the button tells the MFP 10 to acquire the requested data and send the data back to the nurse's computer 15 using the TCP IP address information contained in the temporary profile.

Once the host computer 15 receives the data acquired by the MFP 10, the DLL is again called at step 55 to remove the customized icon 35 from the GUI 30 and return the GUI 30 back to the configuration it had before the addition of the customized icon 35. At the same time, the temporary profile is also removed from the MFP memory.

In some embodiments, the DLL will also assign a time-to-live (TTL) variable to the temporary profile. The TTL variable gives the profile a predetermined life span and can be adjusted based upon the environment the MFP 10 is used in. For example, in some environments, it may be desirable to allow a profile to live for an hour. In other environments, a ten minute life span may be adequate. The TTL variable is also associated with the DLL such that if an information acquisition request is sent to the MFP but then the user does not complete the acquisition at the scanner, the icon 35 and profile will be removed from the MFP 10 upon the expiration of the TTL variable. Should this occur, the DLL would prompt the user on the host computer 15 that the request has timed out and would direct the user to resend the information acquisition request to the MFP 10.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention. For example, various alternatives to the certain features and elements of the present invention are described with reference to specific embodiments of the present invention. With the exception of features, elements, and manners of operation that are mutually exclusive of or are inconsistent with each embodiment described above, it should be noted that the alternative features, elements, and manners of operation described with reference to one particular embodiment are applicable to the other embodiments.

Various features of the invention are set forth in the following claims.

1. A method of associating an icon with a profile in a device store, wherein the device is in communication with a host and has a configurable graphical user interface, the method comprising the acts of:
creating a profile that is associated with at least one action of the device;
generating an icon for display on the graphical user interface upon a request for the acquisition of data from the host; and
associating the profile with the icon.

2. The method of claim 1, further comprising deleting the icon from the device upon the occurrence of an action.

3. The method of claim 1, further comprising deleting the profile from the device upon the occurrence of an action.

4. The method of claim 1, wherein the action is the acquisition of the requested data.

5. The method of claim 1, further comprising assigning a time-to-live variable to the profile.

6. The method of claim 1, wherein the action is the expiration of a time-to-live variable.

7. The method of claim 1, wherein the act of generating an icon for display on the graphical user interface includes the act of polling the graphical user interface to determine if there is enough space on the graphical user interface to add the icon.

8. The method of claim 1, further comprising calling a tool that creates a customized configuration of the graphical user interface.

9. A network accessible by a user, the network comprising:
at least one computer including an application for creating an icon to be associated with a temporary profile; and
at least one multifunction imaging device capable of communicating with the computer, the imaging device having a store that is capable of storing the temporary profile, and having a graphical user interface adapted to display the icon;
wherein the computer causes the application to create the icon based upon information received from a user, place the icon on the graphical user interface.

10. The network of claim 9, wherein the application for creating an icon includes a tool that polls the graphical user interface to see if there is enough space on the graphical user interface to display the icon.

11. The network of claim 9, wherein the store of the imaging device stores a plurality of profiles in a profile list accessible to the user, and wherein the profiles are associated with various functions of the multifunction imaging device.

12. The network of claim 1 1, wherein the functions of the multifunction imaging device include scanning, copying, printing, and faxing.

13. The network of claim 9, wherein the icon is customized to the user.

14. The network of claim 9, wherein the icon is placed on the graphical user interface upon a data acquisition request, and wherein the icon is removed from the graphical user interface upon the acquisition of the requested data.

15. The network of claim 9, wherein the profile is assigned-a time-to-live variable, and wherein the icon is removed from the graphical user interface upon the expiration of the time-to-live variable.

16. The network of claim 9, wherein the computer causes the application to remove the icon after an action has occurred.

17. A method of displaying icons on a graphical user interface of an imaging device, wherein the imaging device is in communication with a host, the method comprising the acts of:
creating a temporary profile in the imaging device upon the request for acquisition of data from the imaging device by the host;
creating a customized icon associated with the temporary profile;
displaying the customized icon on the graphical user interface to create a customized view on the graphical user interface; and
deleting the customized icon from the graphical user interface upon the occurrence of an action.

18. The method of claim 17, further comprising displaying a screen having at least one icon associated with a profile stored in the imaging device and related to a specific operation of the imaging device.

19. The method of claim 17, wherein the action is the acquisition of the requested data.

20. The method of claim 17, further comprising the act of assigning a time-to-live variable to the temporary profile.

21. The method of claim 17, wherein the action is the expiration of the time-to-live variable.

22. The method of claim 17, wherein the act of placing the icon on the graphical user interface the act of includes polling the graphical user interface to determine if there is enough space on the screen to add the icon.

23. A multifunction imaging device, comprising:
an application for creating an icon to be associated with a temporary profile; and
a graphical user interface adapted to display the icon;
wherein said application creates the icon in response to information received from a user and places the icon on the graphical user interface.

24. The multifunction imaging device of claim 23, wherein said application removes the icon after an action has occurred.
